(19) United States
(12) Patent Application Publication
(10) Pub. No.: US 2021/0033795 A1
(43) Pub. Date: Feb. 4, 2021

(54) FIBRE-OPTIC CROSS-CONNECTION SYSTEM

(71) Applicant: Ulrich Lohmann, Hamm (DE)

(72) Inventor: Ulrich Lohmann, Hamm (DE)

(21) Appl. No.: 17/046,131

(22) PCT Filed: May 28, 2018
(86) PCT No.: PCT/EP2018/063908

§ 371 Date: Oct. 8, 2020

(30) Foreign Application Priority Data
Apr. 12, 2018 (DE) 10 2018 002 991.4

(51) Int. Cl. G02B 6/35; H04Q 11/00

(52) U.S. Cl. CPC G02B 6/3542; H04Q 2011/0052; H04Q 11/0005

(57) ABSTRACT

The invention relates to a fibre-optic cross-connection system; in particular having spine-leaf topology, having an input side (S1, S2), in particular a spine side, which has one or a plurality (n) of input switches (S1, S2), Each input switch (S1, S2) comprises a plurality of fibre-optic multi-channel transceivers (QSFP S1.1-S1.4; QSFP S2.1-S2.4), each of which has a number of k fibre-optic channels (Tx0-Tx3). The fibre-optic cross-connection system also has an output side (L1-L4); in particular a leaf side, which has a plurality (m) of output switches (L1, L2, L3, L4) which each have a plurality of fibre-optic multi-channel transceivers (QSFP L1.1-L1.2; QSFP L2.1-L2.2; QSFP L3.1-L3.2; QSFP L4.1-L4.2). The fibre-optic channels (Tx0-Tx3) of at least one, in particular every, input-side multi-channel transceiver (QSFP S1.1-S1.4; QSFP S2.1-S2.4) are divided and connected to output-side multi-channel transceivers (QSFP L1.1-L1.2; QSFP L2.1-L2.2; QSFP L3.1-L3.2; QSFP L4.1-L4.2) which are different from one another, in particular belonging to different output switches (L1, L2, L3, L4).

### CROSS REFERENCE TO RELATED APPLICATIONS

This application is the US National Phase of and claims the benefit of and priority on International Application No. PCT/EP2018/063908 having an international filing date of 28 May 2018, which claims priority on German Patent Application No. 102018002991.4 having a filing date of 12 Apr. 2018.

### BACKGROUND OF THE INVENTION

### Technical Field

The invention relates to a fibre-optic cross-connection system, in particular a plug-in fibre-optic cross-connection system, in particular having spine-leaf topology, having an input side, in particular a spine side, which has one or a plurality of input switches, each input switch comprising a plurality of fibre-optic multi-channel transceivers, each of which has a number of k fibre-optic channels, and an output side, in particular a leaf side, which has a plurality of output switches which each have a plurality of fibre-optic multi-channel transceivers.

### Prior Art

The application of the invention is seen primarily in the field of fibre-optic cabling systems in data centres, since there is a need here for structured and scalable network technology having an inherent redundancy for high data transfer rates. With so-called “spine-leaf topology,” a field of application is developing for highly scalable fibre-optic cross-connections in a redundant design, especially in the field of routers.

In computer centres, a large number of fibre-optic plug-in connection systems exist in different forms (e.g. LC, ST and MPO, etc.). Plug-in cross-connection systems are also known, as can be derived, for example, from DE 10 2011 008 122, U.S. Pat. No. 5,412,506, and DE 10 2016 011 751.

In the existing fibre-optic connection systems, in order to ensure high availability, the number of transceivers used for creating redundancy must be doubled in order to be able to compensate for the failure of a transceiver on an ad hoc basis. This poses a considerable financial expense during purchase and conceptual complexity when planning the space required for such a system. Furthermore, operating this “backup transceiver” produces considerable energy costs and loads the energy balance.

### BRIEF SUMMARY OF THE INVENTION

The problem addressed by the invention is that of providing a cross-connection system of the type mentioned at the outset, which does not have the disadvantages set out above, and in particular is that of creating an inherent redundancy of the electro-optical multi-channel transceiver, even for environments which have a high risk of failure (harsh environment). Inherent redundancy means a hundred percent availability of the data-connections in case of a failure of a transceiver.

This problem is solved by a fibre-optic cross-connection system, in particular having spine-leaf topology, having an input side, in particular a spine side, which has one or a plurality of input switches, each input switch comprising a plurality of fibre-optic multi-channel transceivers, each of which has a number of k fibre-optic channels, and an output side, in particular a leaf side, which has a plurality of output switches which each have a plurality of fibre-optic multi-channel transceivers, characterized in that the fibre-optic channels of at least one, in particular every, input-side multi-channel transceiver are divided and connected to output-side multi-channel transceivers which are different from one another, in particular belonging to different output switches. Advantageous embodiments are the subject matter of the dependent claims.

The fibre-optic cross-connection system for establishing an inherent redundancy in case of a failure of a multi-channel transceiver according to the invention, which in particular comprises a spine-leaf topology, has an input side, in particular a spine side, which has one or a plurality of input switches, each input switch comprising a plurality of fibre-optic multi-channel transceivers, each of which has a number of fibre-optic channels. The cross-connection system according to the invention also has an output side, in particular a leaf side, which has a plurality of output switches, each of which comprises a plurality of fibre-optic multi-channel transceivers. According to the invention, the fibre-optic channels of at least one, in particular every, input-side multi-channel transceiver are divided and connected to output-side multi-channel transceivers which are different from one another, in particular belonging to different output switches.

By means of the fibre-optic cross-connection system, in particular a plug-in fibre-optic cross-connection system, in which the connections of the input-side and/or output-side multi-channel transceivers are preferably plug-in connections, the individual channels of a multi-channel transceiver can be mixed such that an inherent redundancy is thus created by the internal, crossed optical channels, in particular in a connection device. As a result, the system is capable of proportionally compensating for failures of the transceivers in the so-called split mode of the multi-channel transceivers.

The possible reduction of transceivers required is considered a substantial advantage of the described fibre-optic cross-connection, i.e. in comparison with the conventional redundant cross-connection—without an internal mixture of the fibre-optic transceiver channels—only half the number of transceivers are still required in order to create a comparable redundancy when the multi-channel transceiver fails.

The connection, in particular a plug-in connection, is preferably produced as a result of the at least one or the plurality of input switch(es) being connected to the plurality of output switches by means of a connection device. The number of corresponding channel inputs of the connection device is directed to the number of channels of the multi-channel transceivers. The connection device preferably has a number of k connection ports for each connected input-side multi-channel transceiver, k designating the number of fibre-optic channels of each input-side multi-channel transceiver. The connection device, according to the invention, divides or splits the channels of each input-side transceiver and accordingly remerges them on the output side.

On the output side, the connection device also preferably has a number of k channel outputs for each connected output-side multi-channel transceiver, k designating the number of fibre-optic channels of each input-side multi-channel transceiver and/or output-side multi-channel transceiver.

The channel inputs and/or channel outputs can be provided e.g. in LC, ST or MPO plug holders. In each plug holder, there are preferably k channel inputs and/or channel outputs, which are interconnected within the connection device according to the cross-connection according to the invention.

The failure of a multi-channel transceiver in an input switch or spine switch causes e.g. only a 25% reduction in the total bandwidth (instead of 100% band width loss in conventional couplings) through the use of the cross-connection according to the invention. As a result, the transceiver modules required for the required redundancy can be reduced, or an inherent redundancy can be achieved using significantly fewer transceivers.

The inventive concept comprises in particular the creation of inherent redundancy in modern spine-leaf topologies in data centres. This is achieved by combining a fibre-optic cross-connection, preferably a plug-in fibre-optic cross-connection, with the so-called “split mode” of a commercial multi-channel transceiver, and is suitable in particular for high-performance data connections with regard to high Gbps.

The cross-connection according to the invention, preferably a plug-in cross-connection, mixes the individual fibre-optic channels of the multi-channel transceiver with a number of channels k in a modular manner. As a result, the potential failure of a multi-channel transceiver results only in a band width reduction by a factor of 1/k, instead of in a complete bandwidth failure in the conventional embodiment.

This is made possible by the channels of the individual transceivers present in the input switch first being divided, then crossed by the number of connected terminals or output switches, and then remerged. As a result, a transceiver failure involving k-channels only affects the entire system to a factor of 1/k.

It is therefore possible to produce the required systemic redundancy of the electro-optical transceivers using significantly fewer transceivers instead of by doubling the components.

In a spin-leaf constellation having n spine switches and m leaf switches, the number of fibre-optic connections A for the system is the following:

A=mn

With two transceivers per connection, the number of required transceivers N in the conventional redundancy scheme (doubling) is the following:

N₁=4mn

On the basis of the system according to the invention, the number of required k-channel transceivers for the same redundancy is the following:

$${N}_{2} = 2 m n + ( n ⌈ \frac{m}{k} ⌉ + m ⌈ \frac{n}{k} ⌉ )$$

The brackets notation ┌x┐ means the ceiling function, it is the smallest integer x greater or equal n/k.

Using a fibre-optic cross-connection system according to the invention reduces the necessary number of additional transceivers for stablishing inherent redundancy. The total number N2 of input-side and output-side multi-channel transceivers thus becomes less than 4 mn.

In a special embodiment of the invention one can reduce the number of necessary transceivers for inherent redundancy to:

$${N}_{2} = 2 m ( n + [ \frac{n}{k} ] )$$

For a 4-channel transceiver (k=4), the result is then the following:

$${N}_{2} = 2 m ( n + [ \frac{n}{4} ] )$$

The difference of the number of required transceivers can thus be calculated to:

$$Δ N = {N}_{1} - {N}_{2} = 2 m ( n - [ A 1 ] ⌈ \frac{n}{4} ⌉ )$$

This relationship results in a linear increase in the absolute savings potential as a function of n and m. For example, ΔN can be calculated for the following constellations:

| n | m | ΔN |
|---|---|---|
| 2 | 2 | 4 |
| 2 | 6 | 12 |
| 3 | 6 | 24 |
| 6 | 8 | 64 |

The cross-connection of the connected transceivers produces a connection combination of the transceiver channels to the input or output side, or spine or leaf side, respectively, which minimises the particular number of each transceiver on the total bandwidth. Consequently, this also minimises the effect of a failure of the particular transceiver.

The cross-connection system according to the invention is, as set out above, scalable as required. The total number N2 of the input-side and output-side multi-channel transceivers required is therefore preferably

$${N}_{2} = 2 m ( n + [ \frac{n}{k} ] ) .$$

In practical applications, multi-channel transceivers having 4 channels are state-of-the-art at present. Therefore, the number of fibre-optic channels of each input-side and/or output-side multi-channel transceiver is preferably as follows: k=4.

The cross connection system described above and below can therefore be used for establishing an inherent 100%-redundancy in case of a failure of a multi-channel transceiver, employing less than 4 nm transceivers.

### BRIEF DESCRIPTION OF THE DRAWINGS

In the following, the invention will be explained in more detail on the basis of an embodiment on the basis of FIGS. 1-5. The embodiment shown in FIGS. 2-4 and discussed is intended only to demonstrate how a cross-connection according to the invention is intended to be set up. A person skilled in the art will recognise that the system can be equipped or escalated using as many switches or multi-channel transceivers as required.

FIG. 1 is a diagram of a conventional, fibre-optic cross-connection system for two spine switches to four leaf switches having redundant optical channels;

FIG. 2 is a diagram of a fibre-optic cross-connection system according to the invention for two spine switches to four leaf switches having inherent redundant channels;

FIG. 3 is a layout example for a first leaf-quad-block cross-connection system for the application of two spine switches to four leaf switches;

FIG. 4 is an exemplary layout diagram of an MPO12 plug-in connector for multi-channel transceivers; and

FIG. 5 is an exemplary diagram of the split connections according to the invention on the example of a QSFP multi-channel transceiver.

### DETAILED DESCRIPTION OF PREFERRED EMBODIMENTS

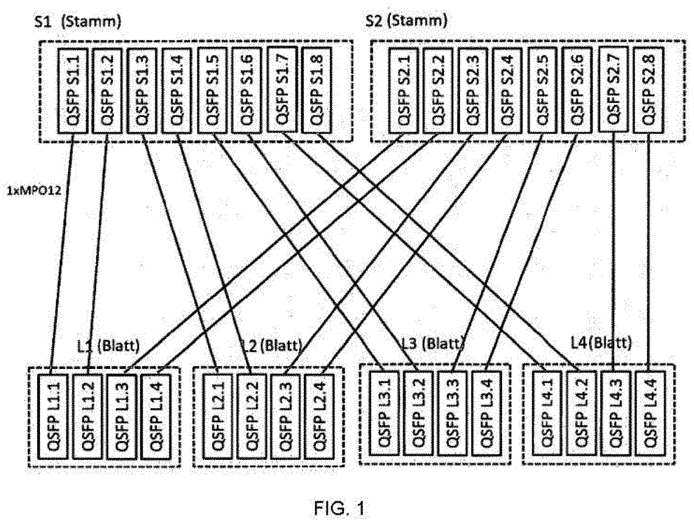

As shown in FIG. 1, the conventional, redundant design, in which a “substitute transceiver” must be provided in order to create the redundancy, requires, e.g. for the depicted spine-leaf connection structure having two spine switches and four leaf switches, a total number of thirty-two multi-channel transceivers QSFP (e.g. QSFP28), each having, for example, four internal fibre-optic channels (Tx and Rx). If, for example, a 100 Gb/s transmission system is used, the four internal channels each transport 25 Gb/s and are conventionally aggregated to 100 Gb/s.

In order to compensate for the failure of a QSFP, the spine switches are each connected to two QSFPs.

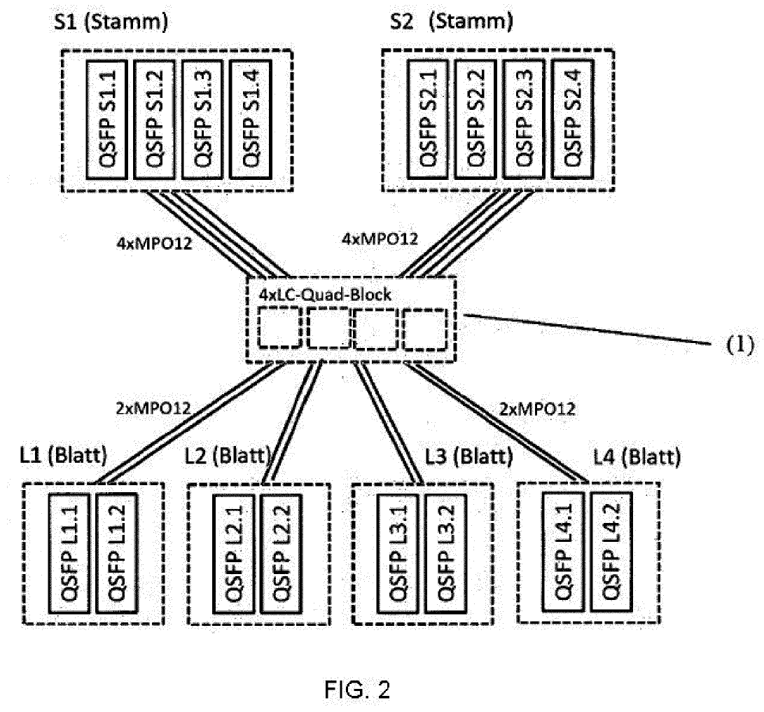

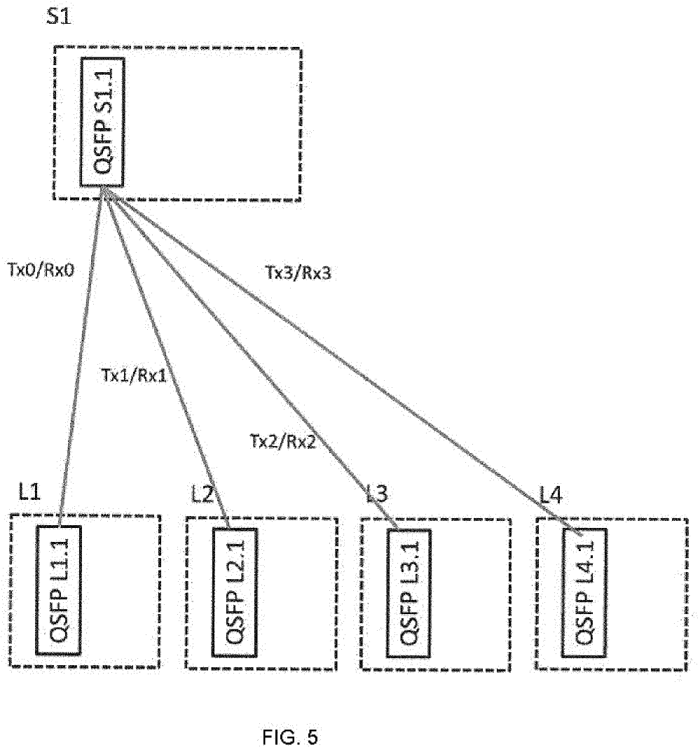

By means of the cross-connection system proposed according to the invention, which in particular is designed as a plug-in connection system, the fibre-optic channels of the connected multi-channel transceivers QSFPx (x is a placeholder), as the example in FIG. 2 shows, are divided by means of the use of the internal split mode of the QSFPs, such that not all, but rather some of the internal channels of the QSFP are switched to the particular receiver apparatus. The division of the four channels of a QSFP is shown, by way of example, in FIG. 5.

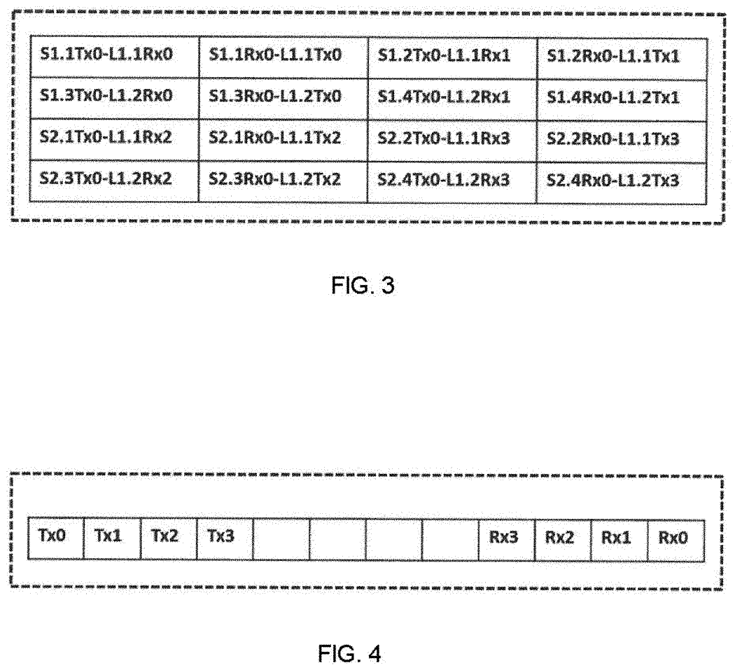

By means of the fibre connections, in particular plug-in fibre connections, of the proposed plug-in connection system, which comprises a connection device 1 in FIG. 2 which connects the input switches (also referred to here as spine switches) to the output switches (also referred to as leaf switches), the data lines are once again mixed together or aggregated using the plug-in scheme shown in FIG. 3, such that the entire data transfer rate can be conveyed to the receiver apparatus.

The plug-in connection from FIG. 3 can be implemented, for example, by means of so-called LC quad-couplings which are used as a connection device in the shown example, it being possible to use, for example, MPO plug-in elements in order to couple the individual channels to the connection device, as shown here by way of example.

The layout of an MPO12 plug-in element is shown in FIG. 4. Using this standard layout, the four internal channels (Tx and Rx) of the connected QSFP are mixed by means of the system according to the invention and, as a result, create the desired inherent redundancy.

In the shown example application, this results in a reduction of 50% in the number of QSFP in the case of proportionally obtained redundancy of the data transfer rate. The calculated proportional redundancy of the data transfer rate increases in this exemplary constellation by means of the fibre-optic channel mixture from 0% to 50% for the leaf switches and from 0% to 75% for the spine switches, since the failure of a QSFP only affects the total data transfer rate by a corresponding proportion owing to the internal split mode.

Consequently, the proposed concept of the inherent redundancy allows a 100% redundancy solution to be developed. For this purpose, in the example application from FIG. 2, the number of multi-channel transceivers used on the spine side increases in each case to six QSFPs per spine and on the leaf side increases in each case to three QSFPs. By means of this constellation, a 100% redundancy is possible in the event of QSFP failure, since the crossed channels of the remaining multi-channel transceivers can be used in order to provide the 100 Gb/s data transfer rate.

As a result of this constellation, the number of multi-channel transceivers required is reduced to 75% of the number of a conventional connection system from FIG. 1.

1. A fibre-optic cross-connection system, in particular having spine-leaf topology, having:
an input side (S1, S2), in particular a spine side, which has one or a plurality (n) of input switches (S1, S2), each input switch (S1, S2) comprising a plurality of fibre-optic multi-channel transceivers (QSFP S1.1-S1.4; QSFP S2.1-S2.4), each of which has a number of k fibre-optic channels (Tx0-Tx3), and an output side (L1-L4), in particular a leaf side, which has a plurality (m) of output switches (L1, L2, L3, L4) which each have a plurality of fibre-optic multi-channel transceivers (QSFP L1.1-L1.2; QSFP L2.1-L2.2; QSFP L3.1-L3.2; QSFP L4.1-L4.2),
wherein
the fibre-optic channels (Tx0-Tx3) of at least one, in particular every, input-side multi-channel transceiver (QSFP S1.1-S1.4; QSFP S2.1-S2.4) are divided and connected to output-side multi-channel transceivers (QSFP L1.1-L1.2; QSFP L2.1-L2.2; QSFP L3.1-L3.2; QSFP L4.1-L4.2) which are different from one another, in particular belonging to different output switches (L1, L2, L3, L4).

2. The fibre-optic cross-connection system according to claim 1,
wherein
the connections of the input-side and/or output-side multi-channel transceivers (QSFP S1.1-S1.4; QSFP S2.1-S2.4; QSFP L1.1-L1.2; QSFP L2.1-L2.2; QSFP L3.1-L3.2; QSFP L4.1-L4.2) are plug-in connections.

3. The fibre-optic cross-connection system according to claim 1,
wherein
the at least one or the plurality (n) of input switch(es) (S1, S2) is/are connected to the plurality (m) of output switches (L1-L4) by means of a connection device (1).

4. The fibre-optic cross-connection system according to claim 3,
wherein
the connection device (1) has a number of k channel inputs for each connected input-side multi-channel transceiver (QSFP S1.1-S1.4; QSFP S2.1-S2.4), k designating the number of fibre-optic channels of each input-side multi-channel transceiver (QSFP S1.1-S1.4; QSFP S2.1-S2.4).

5. The fibre-optic cross-connection system according to claim 3,
wherein
the connection device (1) has a number of k channel outputs for each connected output-side multi-channel transceiver (QSFP L1.1-L1.2; QSFP L2.1-L2.2; QSFP L3.1-L3.2; QSFP L4.1-L4.2), k designating the number of fibre-optic channels of each input-side multi-channel transceiver (QSFP S1.1-S1.4; QSFP S2.1-S2.4) and/or output-side multi-channel transceiver (QSFP L1.1-L1.2; QSFP L2.1-L2.2; QSFP L3.1-L3.2; QSFP L4.1-L4.2).

6. The fibre-optic cross-connection system according to claim 4,
wherein
the channel inputs and/or channel outputs are provided in LC, ST or MPO plug holders.

7. The fibre-optic cross-connection system according to claim 1,
wherein
the total number N2 of input-side and output-side multi-channel transceivers is
$${N}_{2} = 2 m ( n + [ \frac{n}{k} ] ) .$$

8. The fibre-optic cross-connection system according to claim 1,
wherein
the number of fibre-optic channels of each input-side and/or output-side multi-channel transceiver is as follows: k=4.

9. The fibre-optic cross-connection system according to claim 1,
wherein
for establishing an inherent redundancy, the total number N2 of input-side and output-side multi-channel transceivers is less than 4 mn and preferably more than or equal to
$$2 m n + ( n ⌈ \frac{m}{k} ⌉ + m ⌈ \frac{n}{k} ⌉ ) .$$

10. A method for use of a fibre-optic cross-connection system, in particular having spine-leaf topology, having:
an input side (S1, S2), in particular a spine side, which has one or a plurality (n) of input switches (S1, S2), each input switch (S1, S2) comprising a plurality of fibre-optic multi-channel transceivers (QSFP S1.1-S1.4; QSFP S2.1-S2.4), each of which has a number of k fibre-optic channels (Tx0-Tx3), and an output side (L1-L4), in particular a leaf side, which has a plurality (m) of output switches (L1, L2, L3, L4) which each have a plurality of fibre-optic multi-channel transceivers (QSFP L1.1-L1.2; QSFP L2.1-L2.2; QSFP L3.1-L3.2; QSFP L4.1-L4.2),
wherein
the fibre-optic channels (Tx0-Tx3) of at least one, in particular every, input-side multi-channel transceiver (QSFP S1.1-S1.4; QSFP S2.1-S2.4) are divided and connected to output-side multi-channel transceivers (QSFP L1.1-L1.2; QSFP L2.1-L2.2; QSFP L3.1-L3.2; QSFP L4.1-L4.2) which are different from one another, in particular belonging to different output switches (L1, L2, L3, L4),
the method comprising the step of establishing an inherent redundancy in case of a failure of a multi-channel transceiver.
